(19) United States
(12) Patent Application Publication
(10) Pub. No.: US 2004/0032734 A1
(43) Pub. Date: Feb. 19, 2004

(54) Touch-sensitive flickering illuminant

(76) Inventor: Bo-Zong Chen, Keelung (CN)

Correspondence Address: David E. Dougherty, 612 Crystal Square 4, 1745 Jefferson Davis Highway, Arlington, VA, 22202-3417, US

(21) Appl. No.: 10/218,421

(22) Filed: Aug. 15, 2002

(51) Int. Cl. F21L 4/00

(52) U.S. Cl. 362/189; 362/196; 362/200; 362/208; 362/802; 362/103; 36/137

(57) ABSTRACT

The present invention discloses a touch-sensitive flickering illuminant, which comprises a soft plastic body and an operation circuit embedded in the body. The body further comprises a plate with a conducting sheet, the plate is deployed in the center inside the body and a lower cover; the operation circuit is embedded in the holding space between the plate and the lower cover, and after the operation circuit is sealed with high frequency wave or glue, the on-off illuminant groupware is formed after an outer press plate touches the operation circuit via the conducting sheet; and the plate of the flickering illuminant can be various vignettes or enterprise identification signs, and can be widely used in business with the combination of various goods in appropriate manner.

### FIELD OF INVENTION

The present invention relates to a new structure of a flickering illuminant, more particularly to a touch-sensitive flickering illuminant, which can illuminate flickeringly or identify by on-off illuminant groupware touched by press and can be widely used in business with the combination of various goods.

### BACKGROUND OF INVENTION

Referring to FIG. 1, which is a known flickering illuminant A, embedded between the sole B and the mid-sole C, comprises a quiver switch A1, a lead A2 and an illuminating bulb A3, wherein, the quiver switch Al is embedded in the notch B1 prearranged in the sole B, illuminating bulb A3 is leaded by the lead A2 to prearranged location and fixed. The quiver caused by walk touches the operation circuit to turn on or turn off the illuminating bulb A3, and the prearranged location illuminates flickeringly.

The structure of said known flickering illuminant has at least the following drawbacks:

1. The quiver switch is encapsulated with such hard materials as epoxy or acryl, whose volume is big and the quiver switch can be activated by unexpected quiver so that unessential compensation in the battery is done. Furthermore, when the battery gives out, it is need to break the encapsulation with epoxy or acryl strongly by wasting time to recycle, which presses the user who want to take out the spent battery to recycle;

2. It is hard to lead and fix the lead, which is easy to be extruded flexuous to form short circuit.

3. Though waterproofing is done where the quiver switch and the illuminating bulb are electrically connected to the lead respectively, the waterproofing effect is to be tested because the whole is not encapsulated completely.

4. The quiver switch, the lead and the illuminating bulb should be embedded in during the manufacturing process which is more complicated. Once troubled, it is impossible to repair and replace.

5. For the known flickering illuminant because the volume is big, it cannot be used in other goods, therefore the business value is low.

### SUMMARY OF INVENTION

To solve abovementioned problems, inventor acquired lots of experience relating to design and manufacturing to ornaments. And on Aug. 9, 2001 inventor proposed the Taiwanese patent No. 90213754, which is illuminant circuit with trigger switch added in it. Also, when the ornament is embedded in, the trigger raiser on the back of the ornament can corresponds to touch the trigger switch; appropriate hole is deployed at appropriate location of the sole to embed the illuminant; when the illuminant circuit is pressed to trigger the switch, it is activated to emit continuous flicker or stop flicker. It has been granted for its new structure.

However, said patent No.90213754, the inventor think, though it can solve the drawbacks of known art, encapsulation effect in whole and business value in popularity is not ideal. So, in order to keep improving and proposed preferred art, the present invention ‘touch-sensitive flickering illuminant’ appeared after lots of practical design and development.

One object of the present invention is to provide a touch-sensitive flickering illuminant, which can illuminate flickeringly or identify by on-off illuminant groupware touched by press and can be widely used in business with the combination of various goods.

Another object of the present invention is to provide a touch-sensitive flickering illuminant, wherein, the operation circuit is embedded in the holding space of the body made of soft plastic and is sealed with high frequency wave or glue completely.

Another object of the present invention is to provide a touch-sensitive flickering illuminant, wherein, the operation circuit is integrated to a modularized single groupware, and the electrical connection with lead is eliminated.

Another object of the present invention is to provide a touch-sensitive flickering illuminant, wherein, with small volume in whole and without leads the plate of the flickering illuminant can be various vignettes or enterprise identification signs, and can be widely used in other goods to raise business value greatly.

In order to realize these objects, the preferred structure according to the present invention comprises a soft plastic body and an operation circuit in the body. The body further comprises a plate with a conducting sheet, the plate is deployed in the center inside the body and a lower cover; the operation circuit is embedded in the holding space between the plate and the lower cover, and after the operation circuit is sealed with high frequency wave or glue, the on-off illuminant groupware is formed after an outer press plate touches the operation circuit via the conducting sheet.

### BRIEF DESCRIPTION OF DRAWINGS

FIG. 1 is the perspective view of a known touch-sensitive flickering illuminant.

FIG. 2 is the explosion view of the touch-sensitive flickering illuminant of present invention.

FIG. 3 is the combined sectional view of the touch-sensitive flickering illuminant, according to the present invention.

FIG. 4 is the action view of the touch-sensitive flickering illuminant, according to the present invention.

FIG. 5 is the view of an embodiment of a touch-sensitive flickering illuminant using in shoes commercially, according to the present invention.

FIG. 6 is the view of another embodiment of a touch-sensitive flickering illuminant using in shoes commercially, according to the present invention.

FIG. 7 is the view of an embodiment of a touch-sensitive flickering illuminant using in clothes commercially, according to the present invention.

FIG. 8 is the view of an embodiment of a touch-sensitive flickering illuminant using in caps commercially, according to the present invention.

FIG. 9 is the view of an embodiment of a touch-sensitive flickering illuminant using in portfolios commercially, according to the present invention.

FIG. 10 is the view of an embodiment of a touch-sensitive flickering illuminant using in badge of national flag commercially, according to the present invention.

FIG. 11 is the view of an embodiment of a touch-sensitive flickering illuminant using in key ring commercially, according to the present invention.

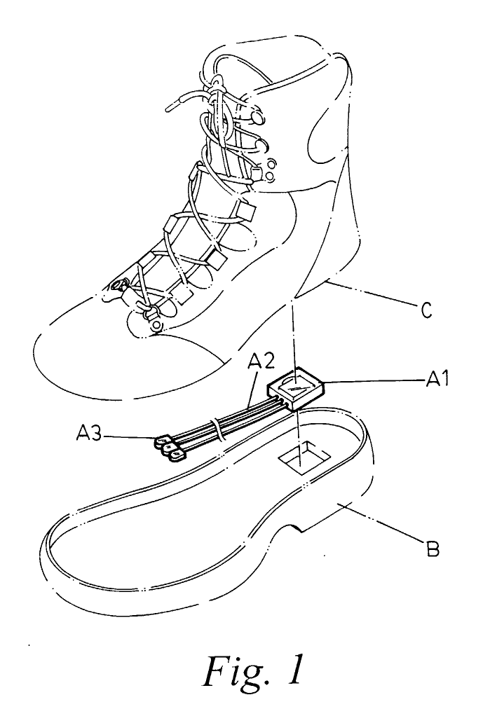

### DETAILED DESCRIPTIONS OF EMBODIMENTS

The detailed description of the present invention will be described according to the drawings.

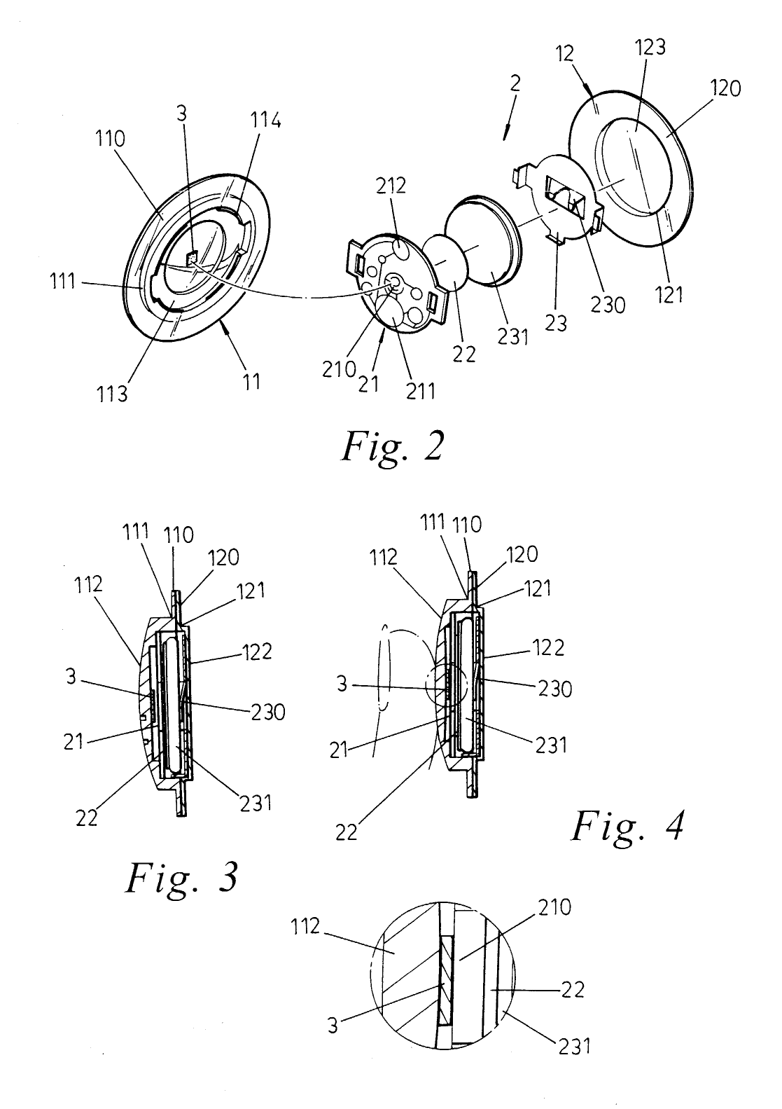

Please referring to the explosion view (FIG. 2), the sectional view after combination (FIG. 3) and the press action diagram (FIG. 4), a touch-sensitive flickering illuminant according to the present invention comprises a soft plastic body 1 and an operation circuit 4 in the body 1, wherein:

The body 1 further comprises a plate 11, which is a relative shallow plate and a lower cover 12. Wherein, the plate 11 extends from the inside 111 of the brim 110 to form an arc ornamental surface 112, and a holding space 113 forms between the brim 110 and the arc ornamental surface 112; the inside 111 of brim 110 extends to form several location sheet 114. The lower cover 12 being a relative shallow plate opposite to said plate 11 extends from the inside 121 of the brim 120 to form an arc surface 122, and a holding space 123 forms between the brim 120 and the arc surface 122; the plate 11 and the opposite lower cover 12 are sealed by the brim 110 of the plate and the brim 120 of opposite lower cover with high frequency wave or glue, the holding spaces 113, 123 between the plate and the lower cover being sealed is to hold exactly the operation circuit, and when the operation circuit 2 was put in the holding space 113 and 123, the location sheet 114 formed when the inside 111 of brim 110 stretches in nips the operation circuit 2 to prevent it from moving around and fix it in the predetermined location when the brim 110, 120 of plate 11 and lower cover 12 are sealed with high frequency wave or glue.

The operation circuit 2 is shown in the figures, which comprises a circuit board 21, a conducting sheet metal 22 and a battery holder 23, wherein known activating circuit 210, IC 211 (integrated circuit) and several LED illuminant groupware 212 are on the circuit board 21. And the battery holder 23 presses at least one button aluminum-manganese (CR series) battery via elastic reed 230, which enables the conducting sheet metal 22 to connect to the circuit board 21 electrically. Once the battery 231 gives out and need to be taken out to recycle, it is easy to take it out only by breaking the seal with scissors or blade.

Corresponding to said activating circuit on the circuit board 21, peilicie conducting sheet 3 is deployed in the center inside the plate 11 of the body 1. As is shown in FIG. 4 (part magnifying view), when the soft plate 11 is pressed to contract, pellicle conducting sheet 3 touches the activating circuit 210 of the circuit board 21 to loop, the LED illuminant groupware 212 will be driven to emit flickering light. In the same way, pressing plate 11 again like above will cut off the loop. Therefore, only simple press can control the LED illuminant groupware 212 easily according to the invention.

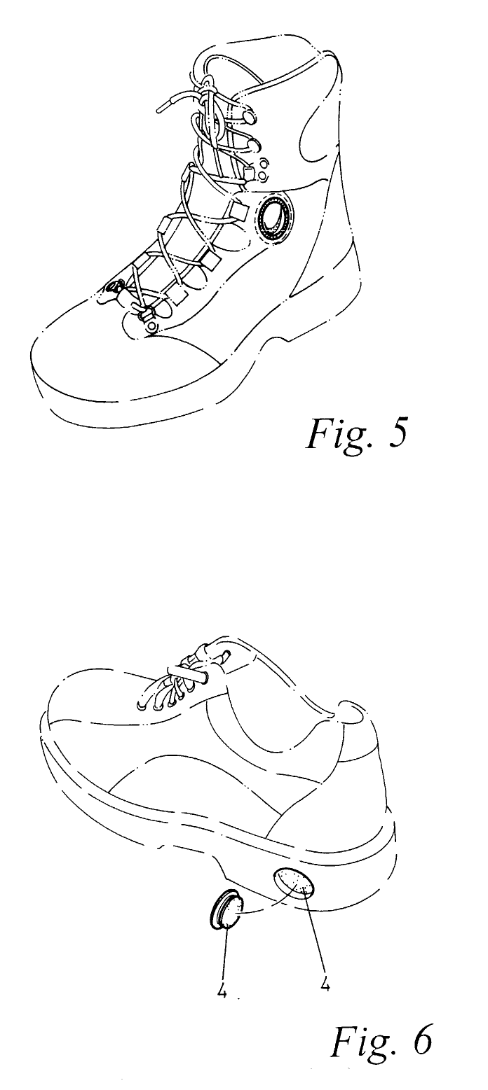

Please referring to FIG. 5, which is an embodiment of the present invention using in shoes commercially. Wherein, the arc ornamental surface 112 can be made beforehand in heat-thaw pressing mould manner to various vignettes in solid bas-relief or enterprise identification signs (CI) designated by clients. According to the embodiment, the arc ornamental surface 112 is the trademark logo of NIKE beforehand. In fact, the NIKE logo can be made to transparent arc surface like the magnifier, which looks like light-diffusion of electronic torch and makes the trademark design prominent. Also, after the plate 11 and the lower cover 12 combined, the brim 110 and 120 can be provided as sealed area, and the sealed with NIKE trademark logo is fixed at appropriate location according to whole design. Once the circuit is activated by the plate 11, the NIKE trademark logo will take on the most garish look under the flickering light.

FIG. 6 discloses another embodiment of the present invention using in shoes commercially. Wherein, after the plate 11 and the lower cover 12 combined, the brim 110 and 120 as sealed edge are ablated, and a devil label 4 is attached on back of the lower cover 12 and it is on the outer side of the heel, and holding hole of the devil label 4 is also deployed inside. With strong glueyness the touch-sensitive flickering illuminant can be fixed on the shoes in another mobile manner. This manner is very much suitable for use in the climbing shoes. When the climbing procession marched at night, the lead of the flickering light can avoid departing from the procession.

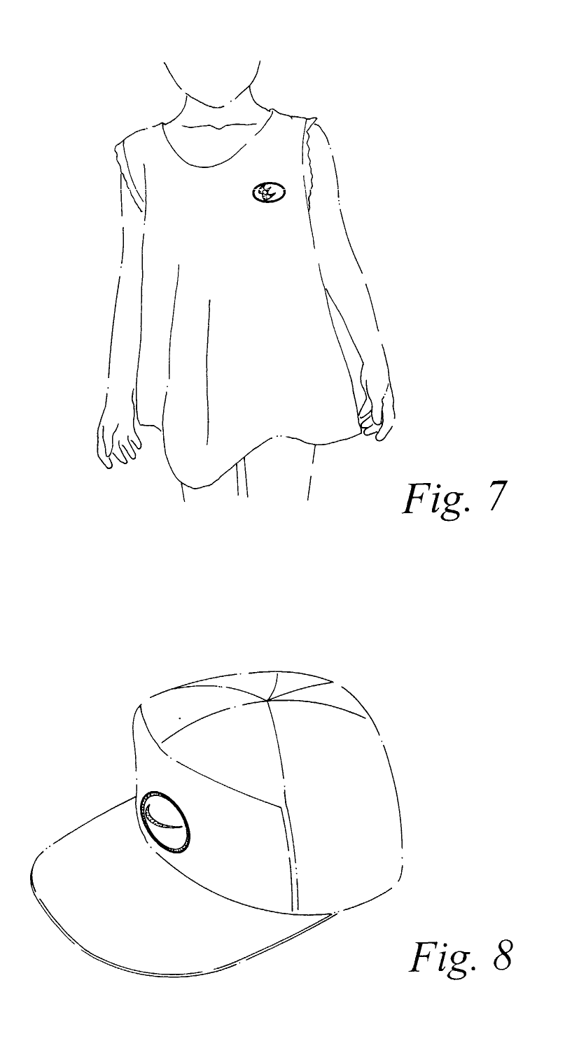

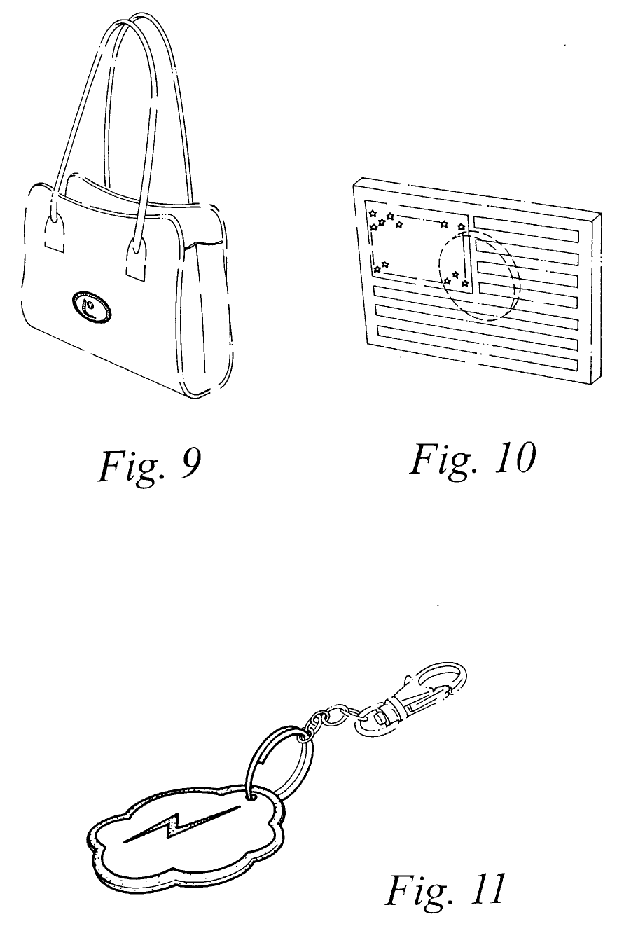

In the same way, as shown in FIG. 7-FIG. 11, the invention can be combined with clothes, caps, portfolio or backpack, badge of national flag, key ring or magnet, which makes them become the most fashionable.

In conclusion, a touch-sensitive flickering illuminant of the present invention comprises a soft plastic body and an operation circuit in the body. And simple press controls the operation circuit to turn on or turn off the illuminant groupware, and the invention is combined appropriately with various goods to use commercially. All above embodiments cannot limit the present invention. Equivalent amendments will not depart from the following claims.

What is claimed is:

1. A touch-sensitive flickering illuminant, mainly comprises a soft plastic body and an operation circuit in the body; wherein the body further comprises a plate deployed in the center inside the body and a lower cover; the operation circuit embedded in a holding space between the plate and the lower cover, and after the operation circuit being sealed with high frequency wave or glue, as the plate being pressed, the illuminant groupware being on or off because the pressed plate touching the operation circuit via the conducting sheet.

2. A touch-sensitive flickering illuminant of claim 1, wherein the plate of the body is a relative shallow plate and extended from the inside of the brim to form an arc ornamental surface, and a holding space being formed between the brim and the arc ornamental surface; the inside of brim extended to form several location sheet to hold the operation circuit.

3. A touch-sensitive flickering illuminant of claim 1, the lower cover being a relative shallow plate opposites to said plate, the lower cover extended from the inside of the brim to form an arc surface, and a holding space being formed between the brim and the arc surface.

4. A touch-sensitive flickering illuminant of claim 3, wherein, the back of the lower cover attaches such groupware as a devil label or a magnet.

5. A touch-sensitive flickering illuminant of claim 2 and 3, wherein, the plate and the opposite lower cover being sealed by the brim of the plate and the brim of opposite lower cover with high frequency wave or glue, the holding spaces between the plate and the lower cover being sealed to hold exactly the operation circuit.

6. A touch-sensitive flickering illuminant of claim 1, wherein, the operation circuit comprises a circuit board, a conducting metal sheet and a battery holder; the circuit board comprising an activating circuit, IC (integrated circuit) and several illuminant groupware, the battery holder having at least one lithium-manganese battery connected to the circuit board by a spring pressing the battery with through the conducting metal sheet.
